(19) United States
(12) Patent Application Publication
(10) Pub. No.: US 2014/0202417 A1
(43) Pub. Date: Jul. 24, 2014

(54) Dynamic Variable Intake Tubing

(71) Applicants: Lin-Lin Kuo, Xiushui Township (TW); Wang-Chun Chen, Xiushui Township (TW)

(72) Inventors: Lin-Lin Kuo, Xiushui Township (TW); Wang-Chun Chen, Xiushui Township (TW)

(21) Appl. No.: 13/745,898

(22) Filed: Jan. 21, 2013

(51) Int. Cl. F02M 35/10

(52) U.S. Cl. CPC F02M 35/10091
USPC 123/184.53

(57) ABSTRACT

A dynamic variable intake tubing includes a dynamic swirl supercharging tube which has a tubular member. The tubular member has a through hole axially penetrated. Flow-guiding grooves which follow a forward helical course or a reverse helical course are disposed on an inner peripheral surface of the through hole. At least a bearing is disposed around an outer circumferential surface of the tubular member to enable the tubular member to rotate freely. Flow-guiding blades are disposed at an intake end of the tubular member for ushering in gas current and guiding the gas current to the flow-guiding grooves. The flow-guiding grooves speed up intake and render combustion complete while an engine is operating at high rotational speed. The dynamic variable intake tubing generates an appropriate back pressure while the engine is operating in low speed, thereby increasing torque output and enhancing the performance of the dynamic swirl twofold to fivefold.

### BACKGROUND OF THE INVENTION

1. Field of the Invention

The present invention relates to vehicle intake control, and more particularly, to a dynamic variable intake tubing which is characterized by a plurality of flow guiding blades formed at the inlet end and a plurality of helical flow-guiding protuberances and grooves formed in an inner peripheral surface of the inner tube and at least a bearing and an outer tube to allow dynamic rotation of the inner tube in various engine revving speeds to constitute a dynamic swirl supercharging tube, so as to optimize air intake and fuel combustion, hence generating more horsepower at higher revving range of an engine and realizing more torque at its lower revving range without sacrificing fuel economy and emission control. Moreover, the present invention improves throttle response at all ranges.

2. Description of the Prior Art

In a typical internal combustion engine, the combustion of a fuel (normally a fossil fuel) occurs with an oxidizer (usually gas, or more particularly, oxygen in the air) in a combustion chamber that is an integral part of the working fluid flow circuit to transform petro-chemical energy into useful mechanical forces. A typical engine normally comprises an injector coupled to a combustion chamber for supplying gas and/or injecting fuel into the combustion chamber with manifolds or intake tubing members, and for allowing the gas and/or fuel to be suitably combusted.

However, compared to what ideal combustion needs at various revving ranges, the variable range of air intake of a typical internal combustion engine may only be limited. In other words, it responds accordingly in predetermined speeds, but may not allow the pressurized fuel and/or gas to flow into the manifolds or intake tubing members in different speeds. Hence, when the engine is operated in high speed, the insufficiency of air supply may tend to cause incomplete combustion, thereby adding to excessive fuel consumption, carbon deposit and air pollution without achieving its power potential. On the contrary, when the engine is operated in low speed, the air intake volume may tend to reach a level higher than optimally required and thus will result in low torque. The inventor's prior patent (U.S. Pat. No. 6,997,214 B2) has arisen to mitigate and/or obviate the afore-mentioned disadvantages of the conventional intake tubing members for engines, and the present invention further widens the scope to adjust and/or to regulate the flowing speed and flowing quantity of pressurized air and/or fuel into the engine cylinders as well as improves throttle response at all revving ranges.

### SUMMARY OF THE INVENTION

Based on the inventor's prior patent (U.S. Pat. No. 6,997,214 B2), the primary objective of the present invention is to provide a dynamic variable intake tubing for even further adjusting or regulating the flowing speed and flowing quantity of pressurized air and/or fuel into the engine cylinders as well as for improving throttle response at all revving ranges.

In accordance with one aspect of the invention, a plurality of flow-guiding blades is formed at an inlet end of the inner tubular member and a plurality of flow-guiding protuberances and grooves is disposed on an inner peripheral surface of the inner tubular member. At least a bearing and an outer tubular member are disposed around an outer circumferential surface of the inner tubular member of the intake tubing, such that the inner tubular member can undergo dynamic rotation in different engine speeds. When an engine is operated in low speeds, the blades at the inlet end as well as the helical protuberances and grooves naturally aide to maintain a proper back pressure and generate eddy current to lower the flowing speed of the fluid and/or gas current such that a proper torque can be achieved without sacrificing fuel economy. When an engine is operated in high speeds, the blades as well as the helical protuberances and grooves may drive the inner tubular member to rotate quickly enough to even further speed up the fluid through the tubular member and to increase power of the engine by improving air intake and combustion efficiency.

In order to achieve the above objectives, the present invention provides a dynamic variable intake tubing, comprising a dynamic swirl supercharging tube. The dynamic swirl supercharging tube comprises an engineered tubular member which has a straight hole in the axial direction. A plurality of flow-guiding blades at the inlet end of the tubular member and a plurality of helical protuberances and grooves which follow a forward or reverse helical course are formed on an inner peripheral surface of the tubular member. At least a bearing is disposed around an outer circumferential surface of the tubular member to allow the inner tube to undergo rotation in response to different engine revving speeds. The flow-guiding blades are disposed at the inlet end of the inner tube to usher in fluid and/or gas current and guide the fluid and/or gas current into the flow-guiding grooves smoothly. Hence, once the fluid and/or gas current comes into contact with a plurality of flow-guiding blades, protuberances and grooves when the engine is operated in high speeds, the flow-guiding blades, protuberances and grooves may speed up the rotation of the inner tubular member and the fluid through the intake tubing into the engine so as to increase power output. When the engine is operated in low speeds, a plurality of flow-guiding blades, protuberances and grooves of the dynamic variable intake tubing naturally aides to generate eddy current and to generate an appropriate back pressure to achieve proper torque output. Intake efficiency-wise, this newly engineered device may improve performance up to twofold to threefold compared with my afore-mentioned prior invention, especially when the engine is operated in high speeds. The present invention features a simple yet effective structure for complete combustion, which maintains or improves torque at lower revving ranges and increase horsepower at higher revving ranges without sacrificing fuel economy and emission control while improving throttle response at all revving ranges.

### BRIEF DESCRIPTION OF THE DRAWINGS

Objectives, features, and advantages of the present invention are hereunder illustrated with specific embodiments in conjunction with the accompanying drawings, in which:

FIG. 1 is a partial cross-sectional view of a pipeline of an internal combustion engine of an embodiment of the present invention;

FIG. 2 is a schematic perspective view of a supercharging tube according to an embodiment of the present invention;

FIG. 3 is a schematic perspective view of the supercharging tube according to another embodiment of the present invention;

FIG. 4 is a schematic perspective view of the supercharging tube according to yet another embodiment of the present invention;

FIG. 5 is a schematic view of a flowing state in the supercharging tube when the engine is operated at low speed or at high speed according to the present invention;

FIG. 6 is a schematic front view of a rotation state of a pipe of the supercharging tube according to the present invention; and

FIG. 7 is a schematic perspective view of the supercharging tube according to a further embodiment of the present invention.

### DETAILED DESCRIPTION OF THE PREFERRED EMBODIMENT

The present invention provides a dynamic variable intake tubing.

During a stroke, work W done by an internal combustion engine of specific combustion efficiency is calculated with the equation as follows:

W=∫PdV

V denotes discharge, and P denotes pressure. The work done by an engine increases with discharge and pressure. The dynamic variable intake tubing of the present invention is characterized in that wind drag in the intake manifold generates an appropriate back pressure while the engine is operating in low speed, whereas fuel is evenly mixed to thereby speed up intake and discharge while the engine is operating at high rotational speed, thereby enhancing combustion efficiency and increasing the work done by the engine.

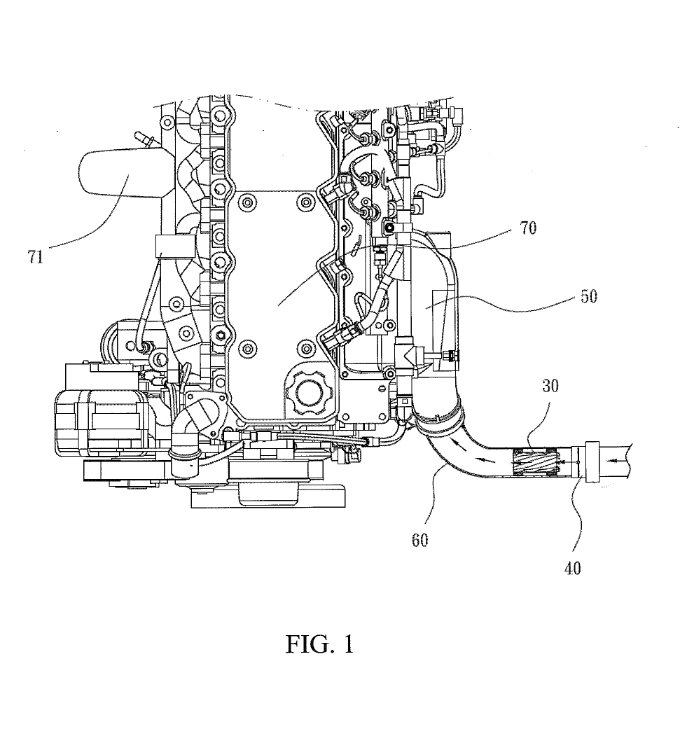

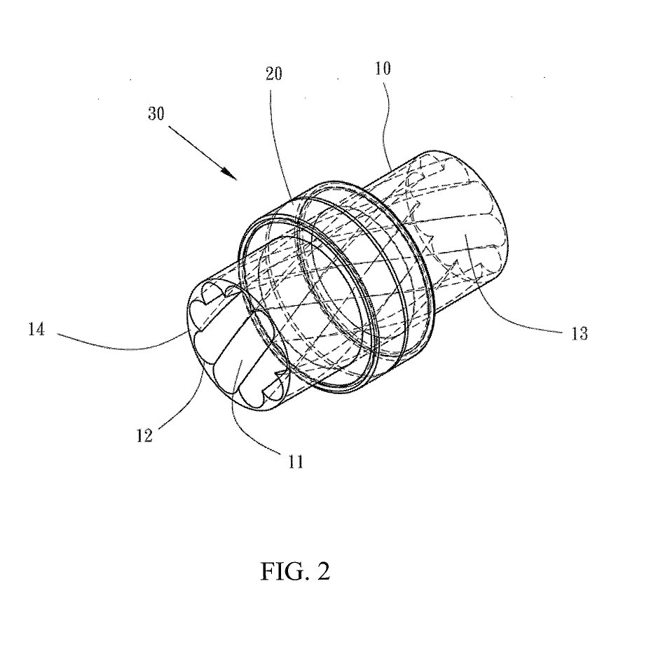

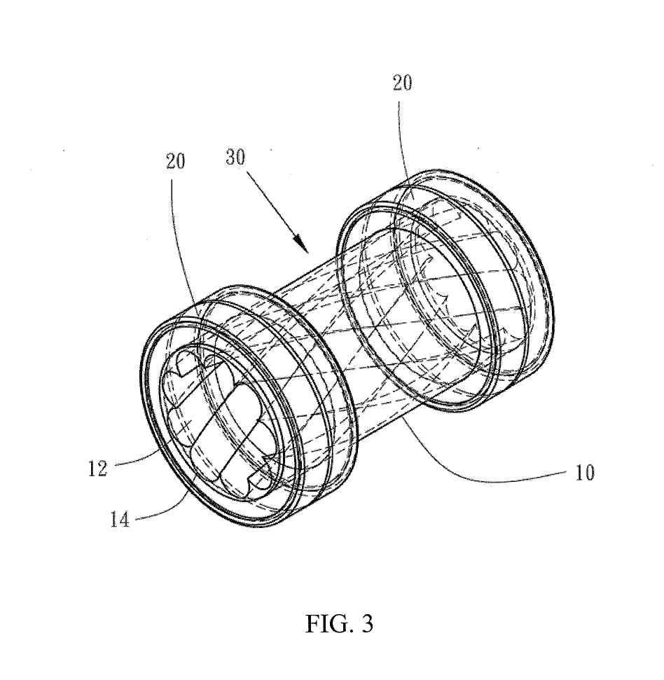

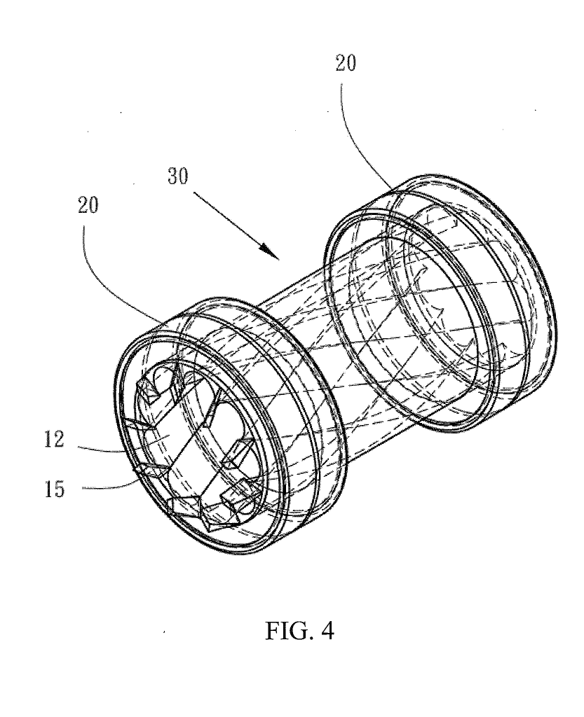

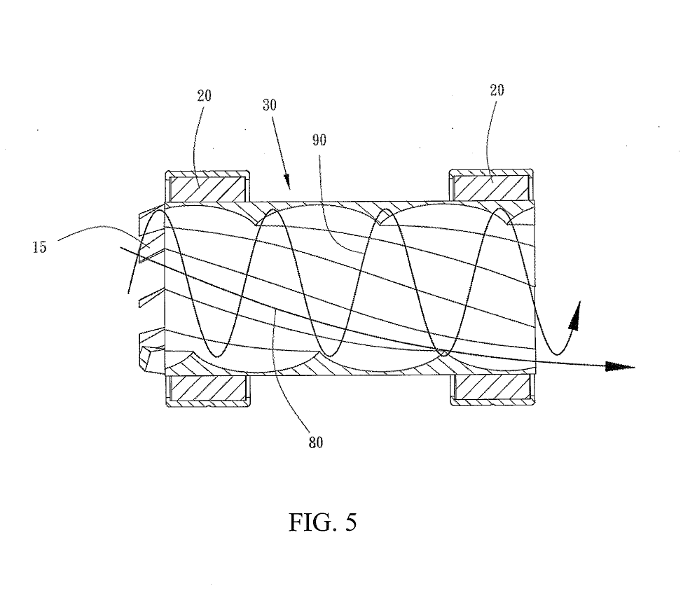

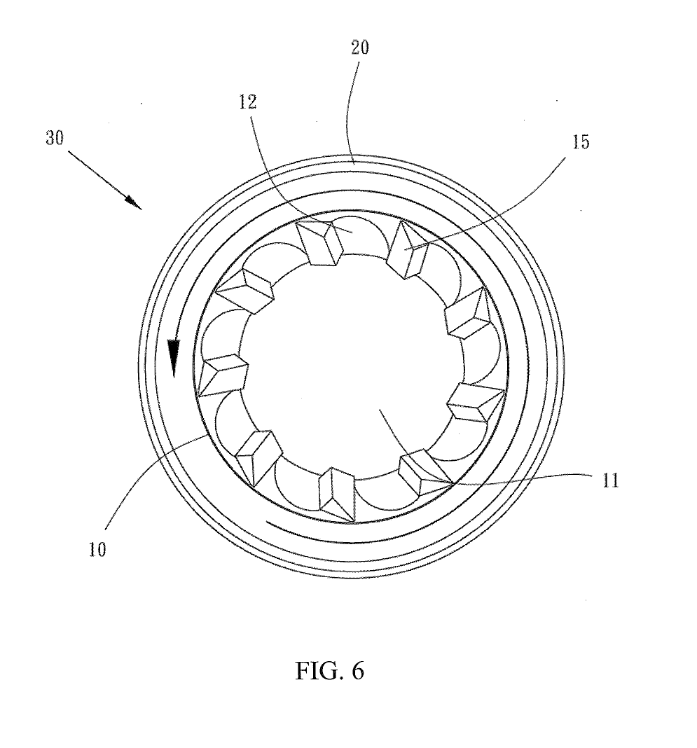

Referring to FIG. 1 through FIG. 6, the present invention provides a dynamic variable intake tubing which comprises a pipe 10 and at least a bearing 20.

The pipe 10 has a through hole 11 axially penetrated. A plurality of flow-guiding grooves 12 which follows a forward helical course is disposed on an inner peripheral surface of the through hole 11. Alternatively, the plurality of flow-guiding grooves 12 follows a reverse helical course.

At least a bearing 20 is disposed on an outer circumferential surface 13 of the pipe 10 to enable the pipe 10 to rotate freely while being supported by the at least a bearing 20. In doing so, a supercharging tube 30 is formed, and the supercharging tube 30 can be installed inside an intake manifold 50 of a vehicle, in front of or behind a throttle body 40 or an outgoing pipeline 71 of the vehicle to allow the engine operating in low speed to generate an appropriate back pressure, allow the engine operating in low speed to increase torque, and allow the engine operating at high rotational speed to have fluid and/or gas current undergoing rapid rotation 90 and therefore have a larger intake to thereby enhance horsepower, render combustion complete, and save fuel.

When a test is carried out with parameters “a capacity of 1000 cc” and “an opening of a diameter of 28 mm”, it typically takes 9.97 seconds for air to pass an intake manifold with a capacity of 1000 cc. When a test is carried out on a swirl supercharger previously devised by the inventor of the present invention, it takes 5.27 seconds for air to pass an intake manifold with a capacity of 1000 cc. When a test is carried out on the dynamic variable intake tubing of the present invention, it takes 3.12 seconds for air to pass an intake manifold with a capacity of 1000 cc to thereby demonstrate the acceleration effect of the present invention. If an engine with an internal combustion engine 70 is operating in low speed and needs to maintain a torque and a low intake, the dynamic variable intake tubing will generate an appropriate back pressure 80 such that the engine with the internal combustion engine 70 can maintain a torque when operating in low speed. If the engine with the internal combustion engine 70 is operating at high rotational speed and needs a large amount of air and a large intake, the dynamic variable intake tubing will undergo rapid rotation 90, enable dynamic swirl supercharging, and increase the intake to thereby enhance horsepower, render combustion complete, and save fuel.

The present invention provides a dynamic variable intake tubing, wherein the pipe 10 has an inlet 14. A plurality of Flow-guiding blades 15 arranged in a flow-guiding direction is disposed at the inlet 14. Due to the plurality of flow-guiding blades 15, gas has been being guided in a correct rotational direction before entering the through hole 11 of the pipe 10. In the situation where the engine is operating at high rotational speed, if fluid and/or gas current comes into contact with the plurality of flow-guiding grooves 12 of the pipe 10, the engine will switch from low rotational speed to high rotational speed to thereby increase the intake or discharge, increase the gas flow rate, speed up combustion, or speed up exhaust removal. In the situation where the engine is operating in low speed, if fluid and/or gas current comes into contact with the plurality of flow-guiding grooves 12 of the pipe 10, the low rotational speed will bring about the back pressure 80. The back pressure 80 leads to intake reduction and, in response to a reduction of fuel supplied by a fuel-supplying system, achieves complete combustion of fuel to thereby increase a torque and save fuel. When the engine is operating in low speed, the engine generates the appropriate back pressure 80, such that a large torque is output while the engine is operating in low speed. When the engine is operating at high rotational speed, the present invention enables gas current to undergo rapid rotation 90, increases the intake, enhances horsepower, renders combustion complete, and saves fuel.

With the dynamic variable intake tubing, not only is fluid and/or gas current guided by the Flow-guiding blades 15 into the plurality of flow-guiding grooves 12 which follows a forward helical course or a reverse helical course, but the pipe 10 is also freely driven by fluid and/or gas current to rotate while being supported by the at least a bearing 20. Hence, when the engine is operating at high rotational speed, gas flow rate increases, and thus air is introduced into the cylinders of the internal combustion engine 70 instantaneously to improve the mixing of air and atomized fuel in the cylinders, so as to render combustion complete, enhance combustion efficiency, boost horsepower, and save fuel.

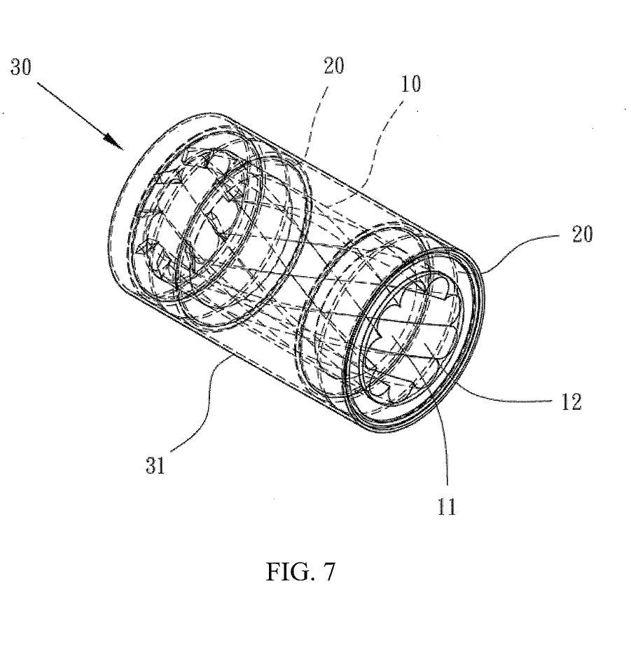

Referring to FIG. 7, the present invention provides a dynamic variable intake tubing which comprises a pipe 10 and at least a bearing 20.

The pipe 10 has a through hole 11 axially penetrated. The plurality of flow-guiding grooves 12 which follows a forward helical course is disposed on the inner peripheral surface of the through hole 11. Alternatively, the plurality of flow-guiding grooves 12 follows a reverse helical course.

The at least a bearing 20 is disposed on the outer circumferential surface 13 of the pipe 10, such that the pipe 10 can rotate freely while being supported by the at least a bearing 20. A bushing 31 is fixedly disposed at an outer periphery of the at least a bearing 20. The bushing 31 is a pipe of a pipeline 60 of the internal combustion engine 70. Alternatively, the bushing 31 is self-contained and fixedly disposed at the outer periphery of the at least a bearing 20. In doing so, the supercharging tube 30 is formed, and the supercharging tube 30 can be installed inside the pipeline 60 between the throttle body 40 and the intake manifold 50 of the vehicle. Alternatively, the pipeline 60 is coupled (not shown) to the supercharging tube 30 having the bushing 31 to enable the engine operating in low speed to generate an appropriate back pressure 80 and achieve an enhanced torque, and enable the engine operating at high rotational speed to have fluid and/or gas current undergoing rapid rotation 90 and therefore have a larger intake to thereby enhance horsepower, render combustion complete, and save fuel.

The supercharging tube 30 is installed inside the outgoing exhaust pipeline 71 of the internal combustion engine 70. Alternatively, the supercharging tube 30 is installed inside an incoming intake pipeline of the internal combustion engine 70. Alternatively, the supercharging tube 30 is installed inside the intake manifold 50. Alternatively, the supercharging tube 30 is installed in front of the throttle body 40 connecting to an inlet of the intake manifold 50. Alternatively, the supercharging tube 30 is installed behind the throttle body 40 connecting to an inlet of the intake manifold 50.

In conclusion, the dynamic variable intake tubing of the present invention is the first-known device of its kind and meets the requirements of novelty of an invention patent, and its comprehensive creative design meets the requirements of inventiveness of an invention patent. The dynamic variable intake tubing of the present invention has industrial applicability, because its flow-guiding grooves together with dynamic rotation are conducive to speeding up and guiding fluid and/or gas current, whereas its intake end is equipped with flow-guiding blades for guiding fluid and/or gas current, so as to increase the intake of an engine operating at high rotational speed and increase the torque of the engine operating in low speed.

What is claimed is:

1. A dynamic variable intake tubing, comprising:
a tubular member having a through hole in the axial direction, the through hole having an inner peripheral surface, wherein a plurality of flow-guiding blades is formed at the inlet end of the tubular member, and a plurality of protuberances and grooves following a helical course is disposed on the inner peripheral surface of the through hole; and
at least a bearing disposed on an outer circumferential surface of the tubular member to allow the tubular member to rotate freely while being supported by the at least a bearing, thereby forming a supercharging tube,
wherein the supercharging tube is installed in an intake manifold lying in an intake direction of an internal combustion engine or installed in front of or behind a throttle body connecting the intake manifold, wherein at least a bearing spaces apart a pipeline and the tubular member, such that the tubular member is still capable of rotating freely in the pipeline, wherein an engine which has therein the internal combustion engine and is operating in low speed features a small operating attraction force such that the rotary supercharging tube ends up with a low rotational speed to thereby generate an appropriate back pressure and increase torque of the engine operated in low speed, wherein the engine which has therein the internal combustion engine and is operated in high rotational speeds features a large operating attraction force such that the rotary supercharging tube ends up with a high rotational speed to thereby drive fluid and/or gas current to speed up and take in air quickly and intensively, so as to enhance horsepower, render combustion complete, and save fuel.

2. The dynamic variable intake tubing of claim 1, wherein the plurality of flow-guiding grooves follows a forward helical course.

3. The dynamic variable intake tubing of claim 1, wherein the plurality of flow-guiding grooves follows a reverse helical course.

4. The dynamic variable intake tubing of claim 1, wherein the tubular member has an inlet, and a plurality of flow-guiding blades arranged in a flow-guiding direction is disposed at the inlet, wherein, due to the plurality of Flow-guiding blades, gas has been being guided in a correct rotational direction before entering the through hole of the tubular member to thereby generate the appropriate back pressure and increase the torque when the engine is operating in low speed and drive the fluid and/or gas current to speed up, enable rapid rotation, and increase intake when the engine is operating at high rotational speed, so as to enhance horsepower, render combustion complete, and save fuel.

5. The dynamic variable intake tubing of claim 1, wherein a bushing is fixedly disposed at an outer periphery of the at least a bearing of the supercharging tube, and an incoming pipeline of the internal combustion engine is coupled to the bushing of the supercharging tube.

6. A dynamic variable intake tubing, comprising:
a tubular member having a through hole axially penetrated, the through hole having an inner peripheral surface, wherein a plurality of flow-guiding grooves following a helical course is disposed on the inner peripheral surface of the through hole; and
at least a bearing disposed on an outer circumferential surface of the tubular member to allow the tubular member to rotate freely while being supported by the at least a bearing, thereby forming a supercharging tube,
wherein the supercharging tube is installed in an outgoing pipeline of an internal combustion engine, and the at least a bearing spaces apart a pipeline and the tubular member such that the tubular member is still capable of rotating freely in the pipeline, wherein in a situation where an engine which has therein the internal combustion engine and is operating in low speed, the rotary supercharging tube ends up with a low rotational speed to generate an appropriate back pressure and increase a torque of the engine operating in low speed, wherein in a situation where the engine which has therein the internal combustion engine and is operating at high rotational speed, the rotary supercharging tube ends up with a high rotational speed to drive fluid and/or gas current to speed up and discharge gas quickly and intensively, so as to enhance horsepower, render combustion complete, and save fuel.

7. The dynamic variable intake tubing of claim 6, wherein the plurality of flow-guiding grooves follows a forward helical course.

8. The dynamic variable intake tubing of claim 6, wherein the plurality of flow-guiding grooves follows a reverse helical course.

9. The dynamic variable intake tubing of claim 6, wherein the tubular member has an inlet, and a plurality of Flow-guiding blades arranged in a flow-guiding direction is disposed at the inlet, wherein, due to the plurality of Flow-guiding blades, gas has been being guided in a correct rotational direction before entering the through hole of the tubular member to thereby generate the appropriate back pressure and increase the torque when the engine is operating in low speed and drive the fluid and/or gas current to speed up, enable rapid rotation, and increase intake when the engine is operating at high rotational speed, so as to enhance horsepower, render combustion complete, and save fuel.

10. The dynamic variable intake tubing of claim 6, wherein a bushing is fixedly disposed at an outer periphery of the at least a bearing of the supercharging tube, and an incoming pipeline of the internal combustion engine is coupled to the bushing of the supercharging tube.

11. A dynamic variable intake tubing, comprising:
a tubular member having a through hole axially penetrated, the through hole having an inner peripheral surface, wherein a plurality of flow-guiding grooves following a helical course is disposed on the inner peripheral surface of the through hole; and
at least a bearing disposed on an outer circumferential surface of the tubular member to allow the tubular member to rotate freely while being supported by the at least a bearing, thereby forming a supercharging tube,
wherein the supercharging tube is installed in an intake manifold or beside an inlet of the intake manifold, wherein the at least a bearing spaces apart a pipeline and the tubular member such that the tubular member is still capable of rotating freely in the pipeline, wherein an engine which has therein the internal combustion engine and is operating in low speed features a small operating attraction force such that the rotary supercharging tube ends up with a low rotational speed to generate an appropriate back pressure and increase a torque of the engine operating in low speed, wherein the engine which has therein the internal combustion engine and is operating at high rotational speed features a large operating attraction force such that the rotary supercharging tube ends up with a high rotational speed to drive fluid and/or gas current to speed up and take in air quickly and intensively, so as to enhance horsepower, render combustion complete, and save fuel.

12. The dynamic variable intake tubing of claim 11, wherein the supercharging tube is installed in front of a throttle body coupling to an inlet of the intake manifold.

13. The dynamic variable intake tubing of claim 11, wherein the supercharging tube is installed behind a throttle body coupling to an inlet of the intake manifold.

14. The dynamic variable intake tubing of claim 11, wherein the tubular member has an inlet, and a plurality of flow-guiding blades arranged in a flow-guiding direction is disposed at the inlet, wherein, due to the plurality of flow-guiding blades, gas has been guided in a correct rotational direction before entering the through hole of the tubular member to thereby generate the appropriate back pressure and increase the torque when the engine is operating in low speed and drive the fluid and/or gas current to speed up, enable rapid rotation, and increase intake when the engine is operating at high rotational speed, so as to enhance horsepower, render combustion complete, and save fuel.

15. The dynamic variable intake tubing of claim 11, wherein a bushing is fixedly disposed at an outer periphery of at least a bearing of the supercharging tube, and an intake pipeline of the internal combustion engine is coupled to the bushing of the supercharging tube.
